(19) United States
(12) Patent Application Publication
(10) Pub. No.: US 2021/0003835 A1
(43) Pub. Date: Jan. 7, 2021

(54) Microscope Stage and Stage Movement Mechanism

(71) Applicant: Global Life Sciences Solutions USA LLC, Marlborough, MA (US)

(72) Inventors: John Tenny Fogelberg, Issaquah, WA (US); Jeremy Cooper, Issaquah, WA (US)

(21) Appl. No.: 16/981,074

(22) PCT Filed: Mar. 25, 2019
(86) PCT No.: PCT/EP2019/057460

§ 371 Date: Sep. 15, 2020

Related U.S. Application Data
(60) Provisional application No. 62/647,253, filed on Mar. 23, 2018.

(51) Int. Cl. G02B 21/26

(52) U.S. Cl. CPC G02B 21/26

(57) ABSTRACT

Disclosed is a microscope stage translation mechanism comprising: a drive rigidly attached or attachable to a bed which drive provides substantially linear motion of a drive element; a rocker arranged for pivoting motion about pivot axis, said axis being stationary relative to said bed, the rocker having a first region arranged to be directly engageable with the drive element, and a second region distant, relative to the axis, from the first region; and a follower having a follower surface arranged to be directly engageable with the second region of the rocker, the follower being attached or attachable to a vertically moveable part of the stage; the mechanism being characterised in that the drive element and the first region have point contact at a first contact point (P) when engaged, and in that the second region and the follower surface also have point contact at a second contact point when engaged.

### TECHNICAL FIELD

The present invention relates to microscope stages, and in particular to movement mechanisms suitable for moving parts of such stages in one or more directions, for example, up and down −Z translations.

### BACKGROUND

Microscope stages are generally required to be highly accurate and repeatable along all motion axes. Typically, a microscope stage will have three orthogonal axes: X, Y, and Z, which are generally defined by the optical axis of the microscope. For most applications, motion along the Z axis which is usually the motion toward and away from optical elements of the microscope, should be characterized by high resolution, for example step distances of less than about 0.10 μm, and high repeatability, for example error between multiple visits to the same targeted Z location of less than about 0.20 μm. Additionally, microscopy systems generally attempt to minimize cross-coupling between motion in the Z and X and Y coordinate axes, since such cross-coupling tends to distort the data captured during imaging operations, which in turn decreases quality and usability of the data acquired. A typical Z scan of a microscope slide may consist of 65 points taken on 0.20 μm intervals, for a total Z axis displacement of 13 μm. Further, Z travel in total should ideally be in the order of 10 mm to accommodate varying height sample mountings.

In accordance with conventional stage technologies, as exemplified in the assignee's U.S. Pat. Nos. 6,781,753 and 5,812,310, the disclosures of which are hereby incorporated by reference in their entirety, a conventional microscopy system stage utilizes a series of linear slides in a ramp configuration. The slides and ramp cooperate to guide a microscope slide, disposed on the stage, in the Z dimension. Such multiple linear slide configurations required to create a Z translation, by necessity, are over-constrained. Consequently, parts tolerance, specifications, and assembly methods must be extremely accurate, to afford repeatable movements. Even so, frictional forces detract from repeatable positioning.

Additionally, conventional systems are typically associated with attendant high costs, which result from the foregoing specification, tolerance, and assembly requirements. For example, six separate linear slides and multiple custom machined plates or slide mounts may be required in order to enable Z axis translation in a conventional system.

One approach to address the above problems is shown in U.S. Pat. No. 7,705,323B2 (further incorporated herein by reference), which uses flexures to provide at least Z movement, albeit with some radial component. However, the means to provide repeatably precise translation is not fully addressed in U.S. Pat. No. 7,705,323B2. Customer expectations are for a relativity open access to the sample mounting area, such an open area also allowing unimpeded relative motion between the sample mounting area and the optical element which are used to investigate the sample. A compact and low cost microscope are also important customer demands. Advances in image analysis mean that 3 dimensional imaging is more common. Relatively fast and repeatable Z movements enhance the ability to provide high quality 3D images. The inventors have realized that the mechanisms used for stage movement can be improved to address the above problems and customer needs/demands.

### SUMMARY OF THE INVENTION

An object of embodiments of the present invention is to provide a microscope stage translation mechanism which gives precise, repeatable position control of a microscope sample stage by means of a linear drive positioned generally horizontally, and arranged to provide generally vertical motion of said stage via a pivotable rocker arm, to transfer horizontal, linear drive motion to vertical positioning within a small vertical space. That objective is enhanced by the preferred features of the mechanism, which have geometry to provide substantially rolling motion between moving parts, thereby minimizing random positioning error which might occur if for example roller bearings were used more widely or wholly sliding elements were employed.

One advantage of the mechanisms described herein is that rolling motion reduces friction which provides a more repeatable repositioning. In addition lower friction reduces wear and so longer term accuracy is maintained

According to an aspect of the invention, there is provided a microscope stage translation mechanism comprising:

a drive rigidly attached or attachable to a bed which drive provides substantially linear motion of a drive element;
a rocker arranged for pivoting motion about pivot axis, said axis being stationary relative to said bed, the rocker having a first region arranged to be directly engageable with the drive element, and a second region distant, relative to the axis, from the first region;
and a follower having a follower surface arranged to be directly engageable with the second region of the rocker, the rocker being attached or attachable to a vertically moveable part of the stage; the mechanism being characterized in that the drive element and the first region have point contact at a first contact point when engaged, and in that the second region and the follower surface also have point contact at a second contact point when engaged.

Preferably said engagements are rolling engagements when linear motion occurs.

Preferably said point contact is provided by opposed cylindrical features or a generally flat surface feature and an opposed generally spherical surface feature, each forming part of the respective drive element, first region, second region or follower surface. Considered positioning and sizing of features allows for almost complete rolling motion of the first and second contact points during relative movement of those features, and allows the force exerted by the drive to be substantially constant during vertical lifting of the stage.

Preferably, one or more of the following features are further provided;

the drive is a liner drive motor arranged horizontally in use;
the drive motor is mounting to a stage which is moveable horizontally, in X and Y directions;
the drive motor output is rigidly connected to the drive element;
the rocker pivot axis is generally horizontal;
the rocker is mounted on a ball or roller element bearings from pivoting about the horizontal axis;
the angular separation between the first and second contact points is less than 90 degrees;
or the angular separation between the first and second contact points is greater than 90 degrees;
the second region supports a vertically moveable part of the stage such as a sample mounting part of the stage, driven or drivable by horizontal movement of the drive or linear drive, translated into vertical motion by said rocker.

More advantages and benefits of the present invention will become readily apparent to the person skilled in the art in view of the detailed description below.

### DRAWINGS

The invention will now be described in more detail with reference to the appended drawings, wherein:

FIG. 1 shows a pictorial view of an embodiment of a microscope stage translation mechanism

FIG. 2 shows an isometric view the embodiment shown in FIG. 1;

FIGS. 3a,b and c show side views of the embodiment of FIGS. 1 and 2 but in different orientations;

FIG. 4 shows a further embodiment of a microscope stage translation mechanism;

FIGS. 5a,b and c show side views of the embodiment of FIG. 4 but in different orientations

### DETAILED DESCRIPTION

Embodiments of a microscope stage translation mechanism are described below in accordance with the principles of the invention.

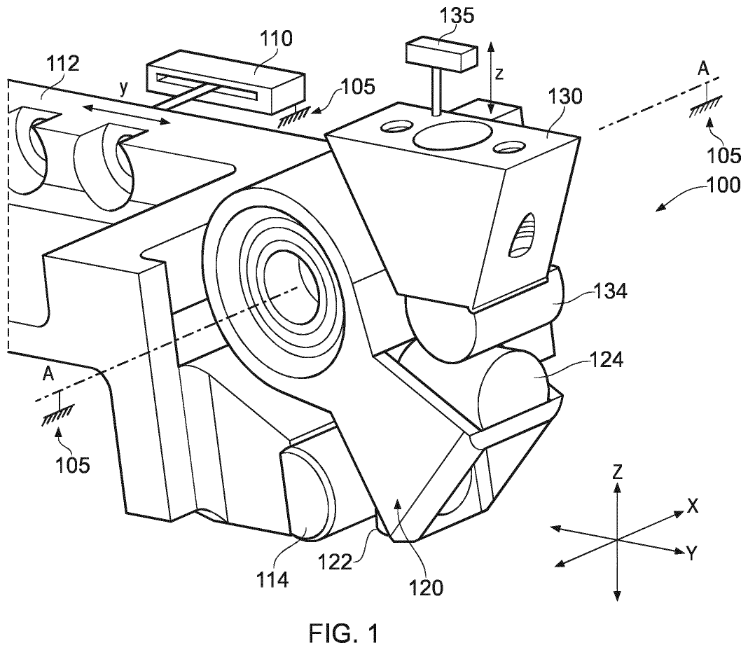

FIG. 1 shows a microscope stage translation mechanism 100, comprising linear drive motor 110, shown schematically, drivingly connected to a drive body 112. The drive body 112 is free to move in the direction of arrow Y under the influence the motor 110. The linear drive motor 110 may, for example be of the type supplied by Aerotech® under the name ‘BLMUC series’. The drive is fixed to a bed 105 which may be parts of a microscope stage independently moveably in the Y and X directions, in this case horizontally. The drive body includes a drive element 114, which in this case is a cylindrical element.

The mechanism further includes a rocker 120, which is pivotable about an axis A-A. Both the linear drive motor 110 and the axis A-A are fixed, relative to said bed 105. The rocker 120 has first and second regions formed from cylindrical elements. The mechanism 100 includes also a follower 130. The follower may support a further part of the microscope stage 135, shown, schematically, for example a sample mounting part of the stage, movable in the Z direction, in this case vertically. The follower 130 includes a follower surface 134.

In use, the drive motor 110 is caused to move in the direction of arrow Y by suitable controlling signals. In turn, this causes the drive element 114 to move, also in the same Y direction. Drive element 114 directly engages with the first region 122 the rocker 120, causing motion rocker about pivot axis A-A. In turn that pivoting motion causes the second region 124 of the rocker 120 pivot in the same manner, which in turn impinges on a flower surface 134, which drives the follower 130 in the Z direction also. Thus, the microscope stage 135 is moved in the Z direction, in this case vertically.

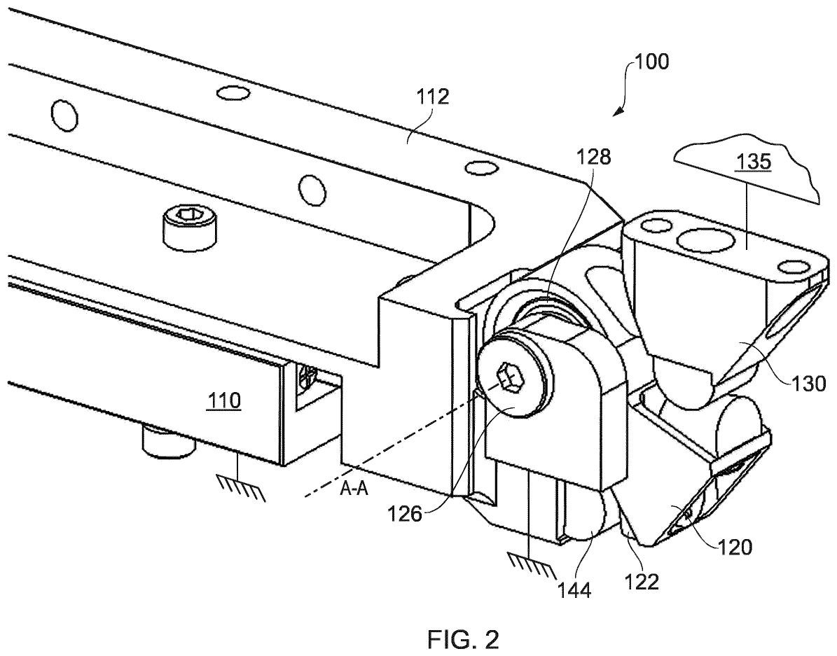

FIG. 2 shows the same embodiment as shown in FIG. 1, although in this figure the linear motor 110 is shown in more detail mounted under the drive body 112 and a pivot pin 126 is shown in place together with its mounting for supporting the rocker 120, by means of roller bearings 128.

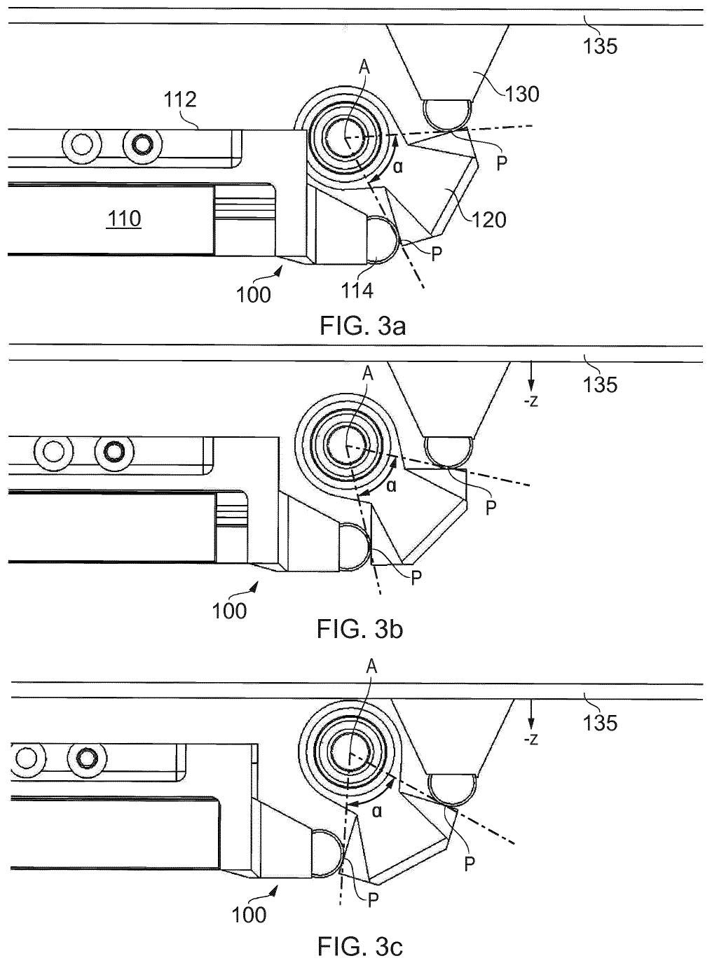

FIGS. 3a, b and c each show the same side view of the embodiment shown in FIG. 1. In FIG. 3a the drive element 114 is extended to the right, causing pivoting of the rocker 120 and lifting of the follower 130 and the stage 135. Driving the motor 110 then to the left will lower the stage 135 as shown FIG. 3b, and further driving of the motor 110 to the left causes further lowering of the stage 135.

In the preceding figures, it can be seen that the drive element 114, first region 122, second region 124 and follower surface 134 are each formed from cylindrical rollers, or parts thereof, and are arranged such that their respective adjacent cylindrical axes are at 90°. Thereby, point contacts P are obtained i.e. contact substantially at only one very small area P. This point contact P provides repeatable positioning compared to contact where a line of material (known as line contact) or flat surface to surface contact is used. Further, as best shown in FIGS. 3a,b and c, the angle α between the pivot axis a-a and the contact points remains substantially constant during use. This, or more accurately, the selection of the geometrical relationship between the cylinder diameters and positioning with respect to the pivot axis A-A, leads to a rolling motion of the point contacts in use, thereby minimising wear at the point contacts. In this case the angle α is less than 90 degrees. As a result of the rolling point contact, accuracy of the drive mechanism is maintained during longer term use.

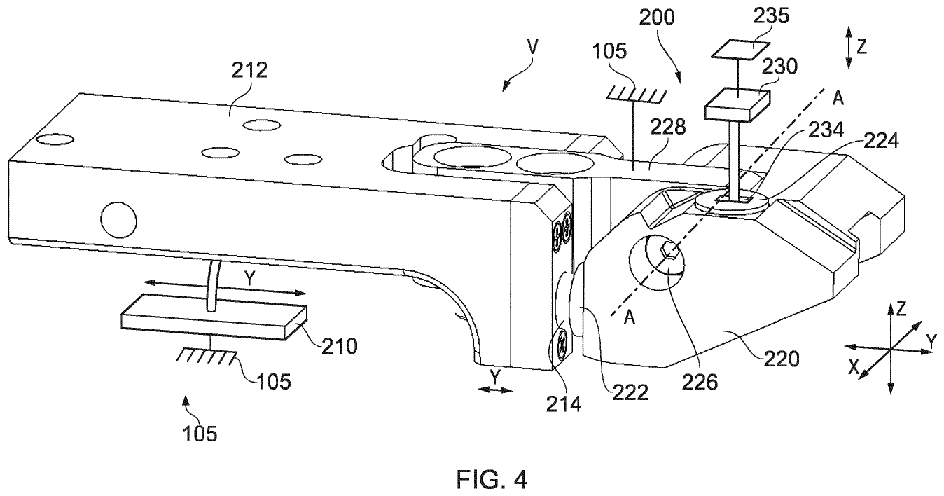

FIG. 4 shows an embodiment similar to the embodiment shown in FIGS. 1, 2 and 3. In this embodiment a microscope stage translation mechanism 200 has a linear drive motor 210, rigidly connected to the bed 105. The motor 210 drives a drive body 212 in the direction of arrow Y which in turn drives a drive element 214 in the same direction. As described in the previous embodiment, the drive element 214 impinges on a first region 222 of a rocker 220. That Y direction movement causes pivoting of the rocker 220 about pivot axis A-A. The rocker is supported by a pivot pin 226 with intermediate roller bearings (not shown) on a pivot support 228 which support is also attached to the bed 105. The rocker has a second region 224 which acts on a follower surface 234 of a follower 230, which in turn causes movement of a stage 235.

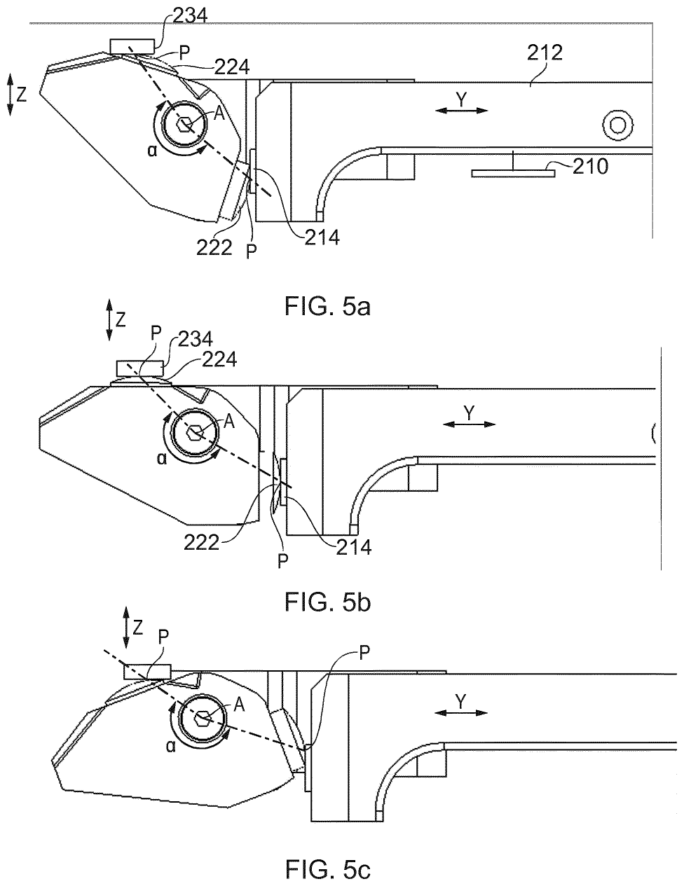

FIGS. 5a b and c, each show side views of the translation mechanism 200, in the direction of arrow V of FIG. 4. In FIG. 5a, the drive element 214 can be more clearly seen as a flat surface, whereas the first and second regions of the rocker part spherical surfaces, and follower surface 234 is also a flat surface. However, the combination of flat surface and spherical surface still provides the point contact P having the advantages mentioned above. In this case, the geometrical relationship of the point contact, the radius of the spheres and their position relative to the pivot axis A-A provides a substantially constant force demand on the linear motor 210 throughout the driving position is shown in FIGS. 5a b and c. It will be noted that the angle α between the contact points P and the axis A-A is greater than 90 degrees in this embodiment and is greater then 180 degrees. The force moments remain constant for the geometry shown.

The invention is not to be seen as limited by the embodiments described herein, but can be varied within the scope of the appended claims as is readily apparent to the person skilled in the art. For instance it is envisaged that the mechanisms 100 or 200 be mounted to a bed 105 that is movable in X and Y directions such that a sample mounting stage also mounted to the bed and movable in a Z direction can be driven up and down by this said mechanism. However, it is entirely possible that the mechanism 100 or 200 can support a stage movable in X and Y and provide further movement of that stage in the Z direction. Key elements of the mechanisms 100 and 200 are the complementary features provided by the drive element and first region of the rocker, and the features of the second region of the rocker and the follower surface. These parts are best formed from hardened material such a 440C hardened steel or ceramic material. The drive motor need not be a linear motor, but should produce linear or near linear motion, so a rotational motor driving a screw, or a crank mechanism for example would suffice, although the linear motor is likely to require less volume than a rotary drive. The references to X Y and Z motions and their conventional relationships corresponding to horizontal and vertical motion is preferred, although that convention need not be followed such that the mechanism is employable to change motion through 90 degrees, not necessarily horizontal the vertical translation. Z motion resulting in about a 10 mm movement range is preferred but more, for example 25 mm or less, for example 2.5 mm is possible, maintaining good accuracy and repeatability.

1. A microscope stage translation mechanism comprising:
a drive rigidly attached or attachable to a bed which drive provides substantially linear motion of a drive element;
a rocker arranged for pivoting motion about pivot axis, said axis being stationary relative to said bed, the rocker having a first region arranged to be directly engageable with the drive element, and a second region distant, from the first region; and
a follower having a follower surface arranged to be directly engageable with the second region of the rocker, the follower being attached or attachable to a vertically moveable part of the stage;
the mechanism being characterised in that the drive element and the first region have point contact at a first contact point when engaged, and in that the second region and the follower surface also have point contact at a second contact point when engaged.

2. The stage as claimed in claim 1, wherein engagement of the contact points is rolling engagement in use.

3. The stage as claimed in claim 1, wherein said point contact is provided by opposed cylindrical features or a generally flat surface feature and an opposed generally spherical surface feature, each forming part of the respective drive element, first region, second region or follower surface.

4. The stage as claimed in claim 1, wherein one or more of the following are further provided;
the drive is a liner drive motor arranged horizontally in use;
the drive motor is mounted to a stage which is moveable horizontally, in X and Y directions;
the drive motor output is rigidly connected to the drive element;
the rocker pivot axis is generally horizontal in use parallel to X plane;
the rocker is mounted on ball or roller element bearings for pivoting about the horizontal axis;
the angular separation between the first and second contact points, with the pivot axis as the origin, is less than 90 degrees; or
the angular separation between the first and second contact points is greater than 90 degrees;
the second region supports a vertically moveable part of the stage such as a sample mounting part of the stage, driven or drivable by horizontal movement of the drive or linear drive, translated into vertical motion by said rocker; and
the moment arms of the mechanism are substantially balanced throughout the range of movement of the mechanism.
